(19) United States
(12) Patent Application Publication
(10) Pub. No.: US 2015/0079966 A1
(43) Pub. Date: Mar. 19, 2015

(54) METHODS FOR FACILITATING TELECOMMUNICATION NETWORK ADMINISTRATION AND DEVICES THEREOF

(71) Applicant: Wipro Limited, Bangalore (IN)

(72) Inventors: Maheshwaran Govindarajeswaran, Chennai (IN); Madanmohan Balasubramanian, Dindigul District (IN)

(73) Assignee: Wipro Limited, Bangalore (IN)

(21) Appl. No.: 14/076,323

(22) Filed: Nov. 11, 2013

(30) Foreign Application Priority Data
Sep. 19, 2013 (IN) 4210/CHE/2013

(51) Int. Cl. H04W 24/00; H04W 8/20

(52) U.S. Cl. CPC H04W 24/00; H04W 8/205
USPC 455/419

(57) ABSTRACT

A method, non-transitory computer readable medium and network management data server device for receiving a service request from a mobile device, where the service request comprises a value for one or more attributes of the mobile device and an indication of at least one of a view profile or one or more network attributes. Network data from a network data snapshot is extracted based on one or more of the indicated view profile or one or more network attributes. A plurality of chunks is generated from the extracted network data based on the value of the one or more attributes of the mobile device. A first one of the plurality of chunks is sent to the mobile device in response to the service request and an additional one of the plurality of chunks in response to each of one or more requests received from the mobile device.

This application claims the benefit of Indian Patent Application Filing Number 4210/CHE/2013, filed on Sep. 19, 2013, which is hereby incorporated by reference in its entirety.

### FIELD

This technology relates to network administration, and particularly to methods for facilitating telecommunications network administration and devices thereof.

### BACKGROUND

As telecommunication networks have become increasingly complex, the effective administration of such networks has become important. Telecommunication network consists of a number of network components which are generally called network elements. Accordingly, while monitoring these network elements large amounts of data is generated. Existing technologies require traditional devices such as a personal computer or a laptop which is used by a telecom network operator to manage and monitor the large amounts of data generated by the network elements within the telecommunication network. Unfortunately, existing technologies do not support managing or monitoring of these large amounts of network data on a mobile device because the mobile device may not be able to handle these large amounts of network data.

### SUMMARY

A method for facilitating telecommunication network administration, including a network management data server device for receiving a service request from a mobile device, where the service request comprises a value for one or more attributes of the mobile device and an indication of at least one of a view profile or one or more network attributes. Network data from a network data snapshot is extracted with the network management data server device based on one or more of the indicated view profile or one or more network attributes. A plurality of chunks are generated from the extracted network data based on the value of the one or more attributes of the mobile device by the network management data server device. A first one of the plurality of chunks is sent to the mobile device in response to the service request and an additional one of the plurality of chunks in response to each of one or more requests received from the mobile device by the network management data server device.

A non-transitory computer readable medium having stored thereon instructions for facilitating telecommunication network administration comprising machine executable code which when executed by at least one processor, causes the processor to perform steps including receiving a service request from a mobile device, where the service request comprises a value for one or more attributes of the mobile device and an indication of at least one of a view profile or one or more network attributes. Network data from a network data snapshot is extracted based on one or more of the indicated view profile or one or more network attributes. A plurality of chunks is generated from the extracted network data based on the value of the one or more attributes of the mobile device. A first one of the plurality of chunks is sent to the mobile device in response to the service request and an additional one of the plurality of chunks in response to each of one or more requests received from the mobile device.

A network management data server device comprising one or more processors, a memory, wherein the memory coupled to the one or more processors which are configured to execute programmed instructions stored in the memory including receiving a service request from a mobile device, where the service request comprises a value for one or more attributes of the mobile device and an indication of at least one of a view profile or one or more network attributes. Network data from a network data snapshot is extracted based on one or more of the indicated view profile or one or more network attributes. A plurality of chunks is generated from the extracted network data based on the value of the one or more attributes of the mobile device. A first one of the plurality of chunks is sent to the mobile device in response to the service request and an additional one of the plurality of chunks in response to each of one or more requests received from the mobile device.

This technology provides a number of advantages including providing more effective methods, non-transitory computer readable medium and devices for facilitating telecommunication network administration. The technology facilitates managing of large amounts of network data generated from the network elements on mobile devices. By way of example only, dividing the network data into a plurality of blocks or chunks and sending these blocks or chunks of network data based on a priority ensures that large amounts of network data is effectively delivered to the mobile devices. Accordingly, this technology provides flexibility to the user of the mobile device such as a network administrator to be able to manage telecommunication network from a mobile device as opposed to from traditional devices such as personal computer(s) or laptop(s).

### BRIEF DESCRIPTION OF THE DRAWINGS

FIG. 1 is an exemplary environment which comprises a network management data server device for facilitating network administration; and

FIG. 2 is an exemplary block diagram of contents a memory of network management data server device; and

FIG. 3 is a flowchart of an exemplary method for facilitating network administration.

### DETAILED DESCRIPTION

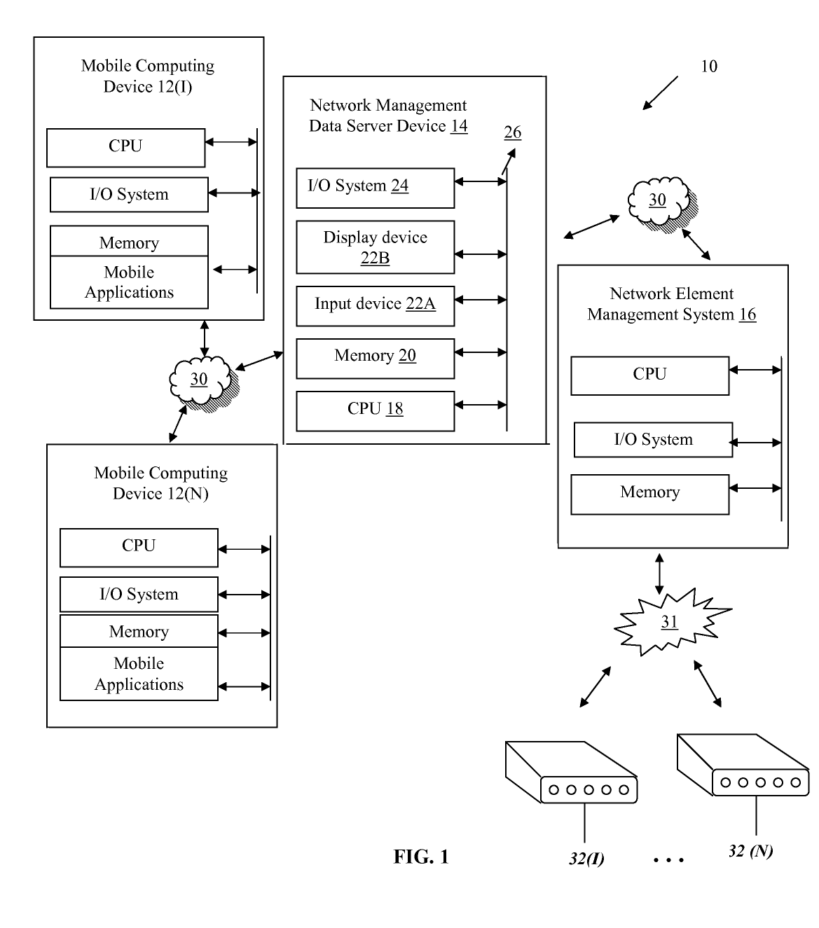

An exemplary 10 with a network management data server device 14 for facilitating telecommunication network administration is as illustrated in FIG. 1. The exemplary environment 10 includes a plurality of mobile computing devices 12(1)-12(N), the network management data server device 14, network element management system 16 and plurality of network elements 32(1)-32(N) which are coupled together by the communication networks 30 and a telecommunication network 31, although the environment can include other types and numbers of devices, components, elements and communication networks in a variety of other topologies and deployments. While not shown, the exemplary environment 10 may include additional components, such as routers, switches and other devices which are well known to those of ordinary skill in the art and thus will not be described here. This technology provides a number of advantages including providing more effective methods, non-transitory computer readable medium and devices for facilitating telecommunication network administration.

Referring more specifically to FIG. 1, the network management data server device 14 interacts with the mobile computing devices 12(1)-12(N) and the network element management system 16 through the communication networks 30 and the network element management system 16 interacts and manages the network elements 32(1)-32(N) through the telecommunication network 31, although the network management data server device 14 can interact with the mobile computing devices 12(1)-12(N) and the network element management system 16 can interact and manage the network elements 32(1)-32(N), using other methods or techniques. Communication networks 30 and the telecommunication network 31 include local area networks (LAN), wide area network (WAN), virtual private networks (VPN) 3G technologies, GPRS or EDGE technologies, although the communication networks 30 and the telecommunication network can include other types and numbers of networks and other network topologies.

The network management data server device 14 facilitates telecommunication network administration within environment 10 as illustrated and described with the examples herein, although network management data server device 14 may perform other types and numbers of functions and in other types of networks. The network management data server device 14 includes at least one processor 18, memory 20, input device 22A and display device 22B, and input/output (I/O) system 24 which are coupled together by bus 26, although network management data server device 14 may comprise other types and numbers of elements in other configurations.

Processor(s) 18 may execute one or more computer-executable instructions stored in the memory 20 for the methods illustrated and described with reference to the examples herein, although the processor(s) can execute other types and numbers of instructions and perform other types and numbers of operations. The processor(s) 18 may comprise one or more central processing units (“CPUs”) or general purpose processors with one or more processing cores, such as AMD® processor(s), although other types of processor(s) could be used (e.g., Intel®).

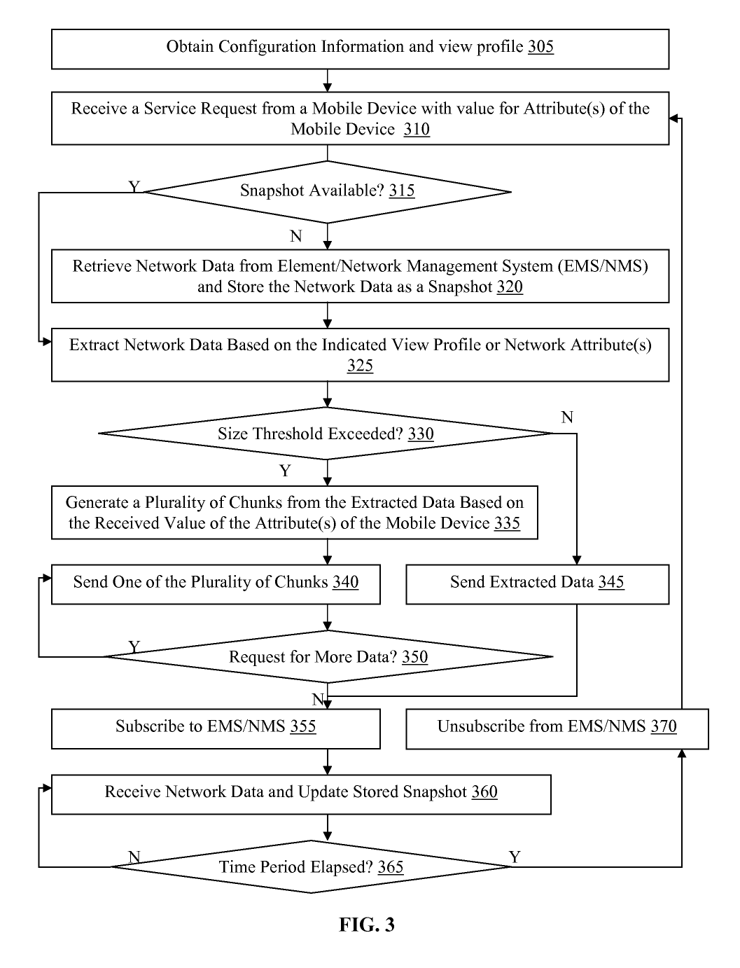

Memory 20 may comprise one or more tangible storage media, such as RAM, ROM, flash memory, CD-ROM, floppy disk, hard disk drive(s), solid state memory, DVD, or any other memory storage types or devices, including combinations thereof, which are known to those of ordinary skill in the art. Memory 20 may store one or more programmed instructions of this technology as illustrated and described with reference to the examples herein that may be executed by the one or more processor(s) 18. The flow charts shown in FIG. 3 is representative of example steps or actions of this technology that may be embodied or expressed as one or more non-transitory computer or machine readable having stored instructions stored in memory 20 that may be executed by the processor(s) 18.

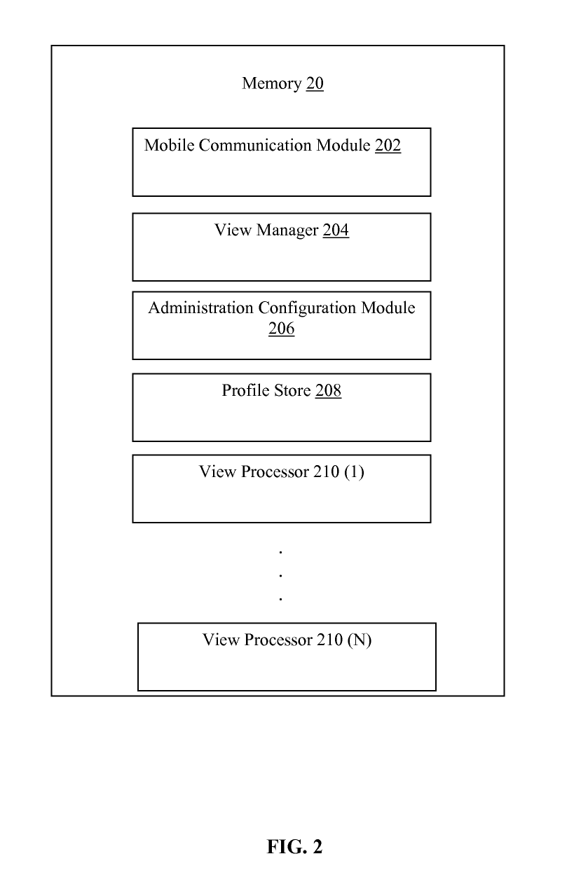

Additionally, as illustrated in FIG. 2, memory 20 comprises a mobile communication module 202, a view manager 204, administration configuration module 206, profile store 208 and a plurality of view processors 210(1)-210(N), although the memory 20 can include other modules or database which would assist the network management data server device 14 with facilitating telecommunication network administration. The mobile communication module 202 assists with receiving requests from the mobile applications executing in the memory of the mobile computing devices 12(1)-12(N) and forwarding a response to the mobile applications executing within the mobile computing devices 12(1)-12(N), although the communication module 202 can be configured to perform other methods to assist with facilitating telecommunication network administration.

Next, the view manager 204 assists with receiving a response from the network element management system 16 via the communication network 30 and stores the received response within the memory 20, although the view manager 204 can be configured to perform methods to assist with facilitating telecommunication network administration. Additionally, the view manager 204 can delete stored responses which are unused for long periods of time.

The administration configuration module 206 in the memory 20 provides configuration support to the network management data server device 14, although the administration configuration module 206 can be configured to perform other methods to assist with facilitating telecommunication network administration. Additionally, in this example, the administration configuration module 206, provides a user interface on the display device 22B using which a user or an administrator of the network management data server device 14 can configure the processor idle timeout and other configurations on the network management data server device 14.

Next, the profile store 208 includes a list of profiles names and profile details of the mobile computing devices 12(1)-12(N), although the profile store 208 can include other types and amounts of information associated with the mobile computing devices 12(1)-12(N). By way of example only, the profile information can include filtered network data snapshot for the received request from the mobile computing devices 12(1)-12(N), although the profile store 208 can include other types of information associated with the mobile computing devices 12(1)-12(N). In this example, using these profiles, the network management data server device 14 can send the network data optimized to the requesting mobile computing device.

The memory 20 also includes a plurality of view processors 210(1)-210(N) which is configured to process the network data received from the network element management system 16, although the view processors 210(1)-210(N) can be configured to perform other methods to assist with facilitating telecommunication network administration. By way of example only, the view processors 210(1)-210(N) breaks down a large amount on network data into a plurality of chunks of network data so that they could be transmitted to the mobile computing devices 12(1)-12(N). Additionally, the view processors 210(1)-210(N) can assist with filtering a network data snapshot based on a view profile or the network data requested by the mobile computing devices 12(1)-12(N). Further in this example, once the network data snapshot is filtered, once or more dynamic attributes associated with the mobile computing devices 12(1)-12(N) are applied on the filtered data by the view processors 210(1)-210(N) within the network management data server 14. Upon applying the one or more dynamic attributes, the view processors 210(1)-210(N) divides the received network data snapshot into a plurality of chunks and prioritizes the plurality of chunks.

Now, with reference to FIG. 1, the network management data server device 14 also includes an input device 22A enables a user, such as an administrator, to interact with the network management data server device 14, such as to input and/or view data and/or to configure, program and/or operate it by way of example only. By way of example only, input device 22A may include one or more of a touch screen, keyboard and/or a computer mouse.

The display device 22B enables a user, such as an administrator, to interact with the network management data server device 14, such as to view and/or input information and/or to configure, program and/or operate it by way of example only. By way of example only, the display device 22B may include one or more of a CRT, LED monitor, LCD monitor, or touch screen display technology although other types and numbers of display devices could be used.

The I/O system 24 in the network management data server device 14 is used to operatively couple and communicate between the network management data server device 14, the mobile computing devices 12(1)-12(N), network element management system 16 and which are all coupled together by communication network 30. In this example, the bus 26 is a hyper-transport bus in this example, although other bus types and links may be used, such as PCI.

Each of the mobile computing devices 12(1)-12(N) includes a central processing unit (CPU) or processor, a memory, an interface device, and an I/O system, which are coupled together by a bus or other link, although other numbers and types of network devices could be used. As illustrated in FIG. 1, the mobile computing devices include mobile applications executing within the memory of the mobile computing devices 12(1)-12(N). Each of the mobile computing devices 12(1)-12(N) sends a request for network data to the network management data server device 14 and receives the requested data from the network management data server device 14 via the mobile applications. Each of the mobile computing devices 12(1)-12(N) communicate with the network management data server device 14 through the communication network 30, although the mobile computing devices 12(1)-12(N) can interact with the network management data server device 14 via other network topologies.

The environment 10 also includes a network element management system 16 which is communicably coupled to the network management data server device 14 via the communication network 30, although the network management data server device 14 and the network element management system 16 can be coupled via other topologies. Further, in this example, the network element management system 16 includes central processing unit (CPU) or processor, a memory, an interface device, and an I/O system, which are coupled together by a bus or other link, although other numbers and types of network devices could be used. In this example, the network element management system 16 manages the network elements 32(1)-32(N) via the telecommunication network, although the network element management system 16 can manage the network elements 32(1)-32(N) via other network topologies. Additionally, in this example, the network element management system 16 captures a network data snapshot of all the network elements 32(1)-32(N) and provides it to the network management data server device 14 upon request, although the network element management system 16 can capture the data associated with the network elements 32(1)-32(N) in other formats.

Additionally, the environment 10 also includes multiple network elements 32(1)-32(N). While not shown, each of the network elements 32(1)-32(N) includes central processing unit (CPU) or processor, a memory, an interface device, and an I/O system, which are coupled together by a bus or other link, although other numbers and types of network devices could be used. The network elements 32(1)-32(N) interacts with the network element management system 16 through the telecommunication network 31, although the network elements 32(1)-32(N) and the network element management system 16 can interact via other network topologies.

Although an exemplary environment 10 includes multiple mobile computing devices 12(1)-12(N), network management data server device 14, network element management system 16 and multiple network elements 32(1)-32(N), as described and illustrated herein, other types and numbers of systems, devices in other topologies can be used. It is to be understood that the systems of the examples described herein are for exemplary purposes, as many variations of the specific hardware and software used to implement the examples are possible, as will be appreciated by those skilled in the relevant art(s).

Furthermore, each of the systems of the examples may be conveniently implemented using one or more general purpose computer systems, microprocessors, digital signal processors, and micro-controllers, programmed according to the teachings of the examples, as described and illustrated herein, and as will be appreciated by those of ordinary skill in the art.

The examples may also be embodied as a non-transitory computer readable medium having instructions stored thereon for one or more aspects of the present technology as described and illustrated by way of the examples herein, as described herein, which when executed by a processor, cause the processor to carry out the steps necessary to implement the methods of the examples, as described and illustrated herein.

An exemplary method for facilitating telecommunication network administration will now be described with reference to FIGS. 1-3. The exemplary method begins at step 305 where the network management data server device 14 obtains configuration information of all types of the mobile computing devices from an external mobile device database (not shown), although the network management data server device 14 can obtain the configuration information and view profile information from other memory locations. By way of example only, the configuration information relates to information associated with the mobile computing devices 12(1)-12(N) such as connection speed, connection bandwidth, processor utilization, memory utilization, memory size, processor speed, threshold size of a memory block, screen size, screen resolution of the mobile computing devices 12(1)-12(N), although the configuration information can relate to other types of information associated with the mobile computing devices 12(1)-12(N). Upon obtaining the configuration information, the network management data server device 14 stores the configuration information within the memory 20 under a unique identifier such as name or type of the mobile computing device, although the network management data server device 14 can store the obtained configuration information at other memory locations.

Next in step 310, the network management data server device 14 receives a service request from one of the mobile computing device 12(1)-12(N) for a snapshot of the network data, although the network management data server device 14 can receive other types and amounts of request from the mobile computing devices 12(1)-12(N). Additionally in this example, along with the service request, the network management data server device 14 also receives dynamic device attributes such as geographical location of the requesting mobile computing device 12(1)-12(N), processor utilization, memory utilization, memory size, processor speed, threshold size of a memory block, screen size, screen resolution or network attributes such as connection speed, connection bandwidth embedded within the service request, although the service request can include other types and amounts of information. The network management data server device 14 compares received information in the service request with the configuration information obtained in the previous step 305 to identify a type and configuration of the requesting mobile computing device 12(1)-12(N), although the network management data service device 14 can perform other types of operations on the information present in the received service request. Optionally in this example, the network management data server device 14 can send a notification to the requesting mobile computing device 12(1)-12(N) confirming the identification of the type of the requesting mobile computing device 12(1)-12(N).

In another example, if the network management data server device 14 does not identify the type and configuration of the requesting mobile computing device 12(1)-12(N), the network management data service device can obtain the type and configuration information associated with the requesting mobile computing device 12(1)-12(N) using the received information in the service request from the external mobile device database (not shown). In yet another example, the service request received by the network management data server device 14 can directly include the type of requesting mobile computing device 12(1)-12(N) using which the network management data server device 14 can obtain the configuration information associated with the requesting mobile computing device 12(1)-12(N).

Next in step 315, the network management data server device 14 determines if the requested snapshot of the network data is available within the memory 20. If the network management data server device 14 determines that the requested snapshot of the network data is not present within the memory 20, then a No branch is taken to step 320. In step 320, the network management data server device 14 obtains the requested snapshot of the network data from the network element management system 16 and then exemplary method directly proceeds to step 325 discussed below, although the network management data server device 14 can obtain the requested snapshot of the network data from other locations. In this example, the network element management system 16 frequently monitors the network elements 32(1)-32(N) and captures a snapshot of the network data associated with the network elements 32(1)-32(N).

If back in step 315 the network management data server device 14 determines that the requested snapshot is present within the memory 20, then a Yes branch is taken to step 325. In step 325, the network management data server device 14 proceeds to extract the network data from the snapshot of the network data based on the network data requested from the mobile computing device 12(1)-12(N) to form a memory block of the network data, although the network management data server device 14 can extract the network data from the snapshot based on other parameters such as type of the requesting mobile computing device 12(1)-12(N), or a requested view profile or other dynamic attributes. In this example, the network management data server device 14 uses information associated with the mobile computing device 12(1)-12(N), such as the network data requested by the mobile computing device 12(1)-12(N), geographical location of the requesting mobile computing device 12(1)-12(N), memory utilization, processor utilization, connection speed, connection bandwidth or screen size, to extract the network data from the snapshot and form the memory block, although the network management data server device 14 can use other types of information associated with the requesting mobile computing device 12(1)-12(N).

In step 330, the network management data server device 14 determines if the size memory block of network data formed during the extraction exceeds the threshold size of a memory block that can be accepted by the requesting mobile computing device 12(1)-12(N) based on the dynamic attributes, such as geographical location of the requesting mobile computing device 12(1)-12(N), connection speed or the connection bandwidth, although the network management data server device 14 can determine if the size memory block of network data from during the extraction exceeds the threshold size of a memory block based on other parameters. If the network management data server device 14 determines that the size of the memory block of network data does not exceed the threshold size of the memory block, then a No branch is taken to step 345 where the network management data server device 14 sends the extracted memory block to the requesting mobile computing device 12(1)-12(N) and exemplary method directly proceeds to step 355.

If back in step 330 the network management data server device 14 determines that the size of the memory block of network data exceeds the threshold size of the memory block acceptable by the requesting mobile computing device 12(1)-12(N), then a Yes branch is taken to step 335. In step 335, the network management data server device 14 divides the memory block of the network data to generate multiple chunks of memory blocks of network data based on the threshold size of the memory block acceptable by the requesting mobile computing device 12(1)-12(N), although the network management data server device 14 can divide the memory block of network data based on other parameters associated with the requesting mobile computing device 12(1)-12(N). By dividing the memory block of the network data to generate multiple chunks of memory, the network management data server device 14 can easily transmit the chunk(s) of to the requesting mobile computing device 12(1)-12(N).

Upon generating multiple chunks of memory blocks of the network data, the network management data server device 14 prioritizes the chunks of memory blocks based on dynamic attributes received in the service request such as a geo-location of the requesting mobile computing device 12(1)-12(N), although the network management data server device 14 can prioritize the chunks of memory blocks based on other parameters. By way of example only, the network management data server device 14 assigns highest priority to the chunk of network data having information associated with the network elements 32(1)-32(N) geographically closest to the requesting mobile computing device 12(1)-12(N) and then sequentially assigns lower priorities to chunks of network data having information associated with the network elements 32(1)-32(N) which are geographically further from the requesting mobile computing device 12(1)-12(N). Alternatively, the network management data server device 14 may assign a low priority to the chunk of network data having information associated with the network elements 32(1)-32(N) geographically closest to the requesting mobile computing device 12(1)-12(N) and then sequentially assigns higher priorities to chunks of network data having information associated with the network elements 32(1)-32(N) which are geographically further from the requesting mobile computing device 12(1)-12(N).

In another example, the network management data server device 14 prioritizes the chunks of memory based on parameters such as memory availability on the requesting mobile computing device 12(1)-12(N), although the network management data server device 14 can consider other parameters associated with the requesting mobile computing device 12(1)-12(N) while prioritizing the chunks of memory. Accordingly, when the memory availability on the requesting mobile computing device 12(1)-12(N) is low, the memory chunk of network data having the lowest size will get the highest priority and the network management data server device 14 will assign the priority to the remaining memory chunks of network data in the increasing order of the size of the memory chunks. Additionally, when the memory availability on the requesting mobile computing device 12(1)-12(N) is high, the network management data server device 14 assigns the highest priority for the memory chunk of network data having the highest size and the network management data server device 14 will assign the priority to the remaining memory chunks of network data in the decreasing order of the size of the memory chunks.

In step 340, the network management data server device 14 sends the memory chunk of the network data with the highest priority to the requesting mobile computing device 12(1)-12(N).

Next in step 350, the network management data server device 14 determines if the requesting mobile computing device 12(1)-12(N) requires additional network data. If the network management data server device 14 determines that the requesting mobile computing device 12(1)-12(N) requires additional network data, then a Yes branch is taken back to step 340 where the network management data server device 14 sends the next prioritized memory chunk to the requesting mobile computing device 12(1)-12(N). By way of example only, the network management data server device 14 can determine if the requesting mobile computing device 12(1)-12(N) requires additional network data by receiving a request for additional data from the requesting mobile computing device 12(1)-12(N), although the network management data server device 14 can use other techniques to determine the requirement for additional network data.

If back in step 350 the network management data server device 14 determines that there is no requirement for additional network data, then a No branch is taken to step 355. In step 355, the network management data server device 14 subscribes for updates from the network element management system 16 relating to any changes in the network data associated with the network elements 32(1)-32(N).

Next in step 360, the network management data server device 14 receives updated snapshot of the network data associated with the network elements 32(1)-32(N) from the network element management system 16 as a response to the subscription. In this example, the updated snapshot of the network data only includes network data which was changed from the previous snapshot of the network data. In another example, the network management data server device 14 can receive the updated snapshot of the network data with both changed and unchanged information associated with the network elements 32(1)-32(N). When the network management data server device 14 receives the updated snapshot of the network data with both changed and unchanged network data associated with the network elements 32(1)-32(N), the network management data server device 14 compares the updated snapshot of the network data with the most recent snapshot of the network data to determine the actual changes to the network data in the updated snapshot. Upon receiving the updated snapshot of the network data, the network management data server device 14 stores the received updated snapshot of the network data associated with the network elements 32(1)-32(N) within the memory 20, although the network management data server device 14 can store the updated snapshot at other memory locations. Optionally in this example, the network management data server device 14 can forward the updated snapshot of the network data to the requesting mobile computing device 12(1)-12(N).

In step 365, the network management data server device 14 determines if a time period for the subscription has elapsed. If the network management data server device 14 determines that the time period for the subscription has not elapsed, then a No branch is taken back to step 360 so that the network management data server device 14 can continue to receive the updated snapshots of the network data and store the updated snapshots of the network data within the memory 20. Additionally in this example, the network management data server device 14 can provide these updated or stored snapshots to the requesting mobile computing device 12(1)-12(N) when the network management data server device 14 receives request for network data within the time period.

If the network management data server device 14 determines that the time period for the subscription has elapsed, then a Yes branch is taken to step 370 where the network management data server device 14 unsubscribes from the network element management system 16 and accordingly does not receive any further updated snapshots of the network data. Additionally, once the network management data server device 14 unsubscribes from the network element management system 16, the network management data server device 14 also deletes all the stored snapshots of the network data after the time period elapses. Accordingly, when there is a new request received by the network management data server device 14 from one of the mobile computing devices 12(1)-12(N) requesting for a snapshot of the network data, the network management data server device 14 again subscribes to the network element management system 16 so that it could receive the updated snapshot of the network data associated with the network elements 32(1)-32(N). Additionally in this example, the time period could be set by a network administrator, although the time period could be set automatically set based on other parameters. Alternatively in another example, the network management data server device 14 can have an unlimited subscription to the network element management system 16 so that it can receive the updated snapshots of the network data when available.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for facilitating telecommunication network administration, the method comprising:
receiving, at a network management data server device, a service request from a mobile device, the service request comprising a value for one or more attributes of the mobile device and an indication of at least one of a view profile or one or more network attributes;
extracting, with the network management data server device, network data from a network data snapshot based on one or more of the indicated view profile or one or more network attributes;
generating, with the network management data server device, a plurality of chunks from the extracted network data based on the value of the one or more attributes of the mobile device; and
sending, with the network management data server device, a first one of the plurality of chunks to the mobile device in response to the service request and an additional one of the plurality of chunks in response to each of one or more requests received from the mobile device.

2. The method of claim 1, wherein the extracting further comprises:
determining, with the network management data server device, whether the network data snapshot is stored; and
retrieving, with the network management data server device, network data from a network or element management system configured to manage the plurality of network elements using a network or element management interface and storing the retrieved network data as a network data snapshot, when it is determined that the network data snapshot is not stored.

3. The method of claim 1, further comprising:
determining, with the network management data server device, whether the extracted network data does not exceed a threshold size; and
sending, with the network management data server device, the extracted network data in response to the service request without generating the plurality of chunks, when it is determined that the extracted network data does not exceed a threshold size.

4. The method of claim 1, further comprising:
subscribing, with the network management data server device, to a network or element management system configured to manage a plurality of network elements of a telecommunications network;
receiving, with the network management data server device, network data from the network or element management system in response to a change associated with one or more of the plurality of network elements;
updating, with the network management data server device, the network data snapshot based on the received network data;
determining, with the network management data server device, whether a specified time period has elapsed; and
unsubscribing, with the network management data sever, from the network or element management system when it is determined that the specified time period has elapsed.

5. The method of claim 1, further comprising:
obtaining, with the network management data server device, one or more view profiles from an administrator;
storing, with the network management data server device, the one or more view profiles in a profile store; and
providing, with the network management data server device, an indication of one or more of the view profiles in response to a request from the mobile device.

6. The method of claim 1, wherein the processing further comprises prioritizing each of the plurality of chunks based on the value of the one or more attributes of the mobile device and the first one of the plurality of chunks is a highest priority chunk.

7. The method of claim 1, wherein the one or more attributes of the mobile device are selected from geographic location, memory utilization, processor utilization, connection speed, connection bandwidth, or screen size.

8. A non-transitory computer readable medium having stored thereon instructions for facilitating telecommunication network administration comprising machine executable code which when executed by a processor, causes the processor to perform steps comprising:
receiving a service request from a mobile device, the service request comprising a value for one or more attributes of the mobile device and an indication of at least one of a view profile or one or more network attributes;
extracting network data from a network data snapshot based on one or more of the indicated view profile or one or more network attributes;
generating a plurality of chunks from the extracted network data based on the value of the one or more attributes of the mobile device; and
sending a first one of the plurality of chunks to the mobile device in response to the service request and an additional one of the plurality of chunks in response to each of one or more requests received from the mobile device.

9. The medium of claim 8, wherein the extracting further comprises:
determining whether the network data snapshot is stored; and
retrieving network data from a network or element management system configured to manage the plurality of network elements using a network or element management interface and storing the retrieved network data as a network data snapshot, when it is determined that the network data snapshot is not stored.

10. The medium of claim 8, further comprising:
determining whether the extracted network data does not exceed a threshold size; and
sending the extracted network data in response to the service request without generating the plurality of chunks, when it is determined that the extracted network data does not exceed a threshold size.

11. The medium of claim 8, further comprising:
subscribing to a network or element management system configured to manage a plurality of network elements of a telecommunications network;
receiving network data from the network or element management system in response to a change associated with one or more of the plurality of network elements;
updating the network data snapshot based on the received network data;
determining whether a specified time period has elapsed; and
unsubscribing from the network or element management system when it is determined that the specified time period has elapsed.

12. The medium of claim 8, further comprising:
obtaining one or more view profiles from an administrator;
storing the one or more view profiles in a profile store; and
providing an indication of one or more of the view profiles in response to a request from the mobile device.

13. The medium of claim 8, wherein the processing further comprises prioritizing each of the plurality of chunks based on the value of the one or more attributes of the mobile device and the first one of the plurality of chunks is a highest priority chunk.

14. The medium of claim 8, wherein the one or more attributes of the mobile device are selected from geographic location, memory utilization, processor utilization, connection speed, connection bandwidth, or screen size.

15. A network management data server device, comprising:
a memory; and
a processor coupled to the memory and configured to execute programmed instructions stored in the memory, comprising:
receiving a service request from a mobile device, the service request comprising a value for one or more attributes of the mobile device and an indication of at least one of a view profile or one or more network attributes;
extracting network data from a network data snapshot based on one or more of the indicated view profile or one or more network attributes;
generating a plurality of chunks from the extracted network data based on the value of the one or more attributes of the mobile device; and
sending a first one of the plurality of chunks to the mobile device in response to the service request and an additional one of the plurality of chunks in response to each of one or more requests received from the mobile device.

16. The device of claim 15, wherein the processor is further configured to execute programmed instructions stored in the memory for the extracting further comprises:
determining whether the network data snapshot is stored; and
retrieving network data from a network or element management system configured to manage the plurality of network elements using a network or element management interface and storing the retrieved network data as a network data snapshot, when it is determined that the network data snapshot is not stored.

17. The device of claim 15, wherein the processor is further configured to execute programmed instructions stored in the memory further comprising:
determining whether the extracted network data does not exceed a threshold size; and
sending the extracted network data in response to the service request without generating the plurality of chunks, when it is determined that the extracted network data does not exceed a threshold size.

18. The device of claim 15, wherein the processor is further configured to execute programmed instructions stored in the memory further comprising:
subscribing to a network or element management system configured to manage a plurality of network elements of a telecommunications network;
receiving network data from the network or element management system in response to a change associated with one or more of the plurality of network elements;
updating the network data snapshot based on the received network data;
determining whether a specified time period has elapsed; and
unsubscribing from the network or element management system when it is determined that the specified time period has elapsed.

19. The device of claim 15, wherein the processor is further configured to execute programmed instructions stored in the memory further comprising:
obtaining one or more view profiles from an administrator;
storing the one or more view profiles in a profile store; and
providing an indication of one or more of the view profiles in response to a request from the mobile device.

20. The device of claim 15, wherein the processor is further configured to execute programmed instructions stored in the memory for the processing further comprises prioritizing each of the plurality of chunks based on the value of the one or more attributes of the mobile device the first one of the plurality of chunks is a highest priority chunk.

21. The device of claim 15, wherein the one or more attributes of the mobile device are selected from geographic location, memory utilization, processor utilization, connection speed, connection bandwidth, or screen size.
